(19) United States
(12) Patent Application Publication
(10) Pub. No.: US 2013/0140243 A1
(43) Pub. Date: Jun. 6, 2013

(54) Method and Plant for Purifying Raw Water

(71) Applicant: Bert Gustafsson, Fagelmara (SE)

(72) Inventor: Bert Gustafsson, Fagelmara (SE)

(21) Appl. No.: 13/696,423

(22) PCT Filed: May 4, 2011
(86) PCT No.: PCT/SE2011/050557

§ 371 Date: Dec. 7, 2012

(30) Foreign Application Priority Data
May 6, 2010 (SE) 1050451-2

(51) Int. Cl. C02F 1/64

(52) U.S. Cl. CPC C02F 1/645
USPC 210/722; 210/532.1; 210/523; 210/258; 210/207; 210/221.2

(57) ABSTRACT

A method of purifying raw water comprises the steps of supplying the raw water to a generally vertical, open-ended inlet cylinder (23) in a reservoir (20), exposing the water in the inlet cylinder (23) to air for accomplishing oxidizing of matter, such as iron, manganese, and hydrogen sulphide in the water and/or agitation of the water, allowing the oxidized matter to fall down by gravity to the bottom of the reservoir (20), allowing the purified water to flow upwards past the inlet cylinder (23) and through a distribution disc (24) in the reservoir (20), and removing the purified water from the upper part of the reservoir (20).

### TECHNICAL FIELD

The present invention relates to a method of purifying raw water. It also relates to a water purification plant comprising a reservoir for receiving raw water to be purified into pure water.

### BACKGROUND OF THE INVENTION

Raw water may be purified into pure water or drinking water in a variety of ways. Besides removing unwanted matter from raw water by a number of filtering methods, it is known to remove for example iron, manganese, and hydrogen sulphide by an oxidation process by means of air introduced in the water, so that oxidized matter can simply be allowed to fall to the bottom of the reservoir in which the water is treated. It is likewise known to remove organic material from sea water and stream water by adding a flocculating agent and removing the formed flocks from the water.

The end result reached in many ways may be satisfactory, but often the used processes may be complicated and involve many steps, whereas the equipment used may be intricate, costly and/or difficult to manage.

The main objects of the invention are thus to reach a water purification method, which is as simple as possible, but which nevertheless gives a satisfactory end result, and to provide a water purification plant, which is simple, effective and low-cost.

### THE INVENTION

A method according to the invention of purifying raw water comprises the steps of

supplying the raw water to a generally vertical, open-ended inlet cylinder in a reservoir,

exposing the water in the inlet cylinder to air for accomplishing oxidizing of matter, such as iron, manganese, and hydrogen sulphide, in the water and/or agitation of the water,

allowing the oxidized matter to fall down by gravity to the bottom of the reservoir,

allowing the purified water to flow upwards past the inlet cylinder and through a distribution disc in the reservoir, and

removing the purified water from the upper part of the reservoir.

The water in the inlet cylinder may also be exposed to a flocculating agent for accomplishing flocculation of for example organic matter in the water, the flocculated matter being allowed to fall down by gravity to the bottom of the reservoir.

A water purification plant according to the invention comprises a reservoir for receiving raw water to be purified into pure water and is characterized by

a generally vertical, open-ended inlet cylinder in the reservoir for receiving raw water,

a nozzle device for supplying air from an air line to the water in the inlet cylinder,

a bottom of the reservoir for receiving matter heavier than water,

a generally horizontal distribution disc, provided with openings and dividing the space inside the reservoir and outside the inlet cylinder into an upper and a lower compartment, and

means for removing purified water from the upper compartment.

The plant may be provided with a flocculating agent line for supplying flocculating agent to the water in the inlet cylinder.

A sludge pump may be arranged at the bottom of the reservoir for occasionally removing the sludge from the reservoir.

The means for removing purified water may comprise a pure water pump connected to a pure water line.

For improving the water quality under certain conditions, a further filtering means may be arranged in the pure water line.

For improving the mixing of the flocculating agent with the raw water, the flocculating agent line may open into a mixing cyclone, through which the raw water flows.

The distribution disc is preferably provided with openings with a size and distribution for accomplishing an even water flow over its area.

### BRIEF DESCRIPTION OF THE DRAWING

The invention will described in further detail below under reference to the accompanying drawings, in which

FIG. 1 is a schematical top view of a water purification plant according to the prior art,

FIG. 2 is a schematical side view of the same plant,

FIG. 3 is a schematical top view of a first embodiment of a water purification plant according to the invention,

FIG. 4 is a schematical side view of the same plant,

FIG. 5 is a schematical top view of a second embodiment of a water purification plant according to the invention, and

FIG. 6 is a schematical side view of the same plant.

### DESCRIPTION OF EMBODIMENTS

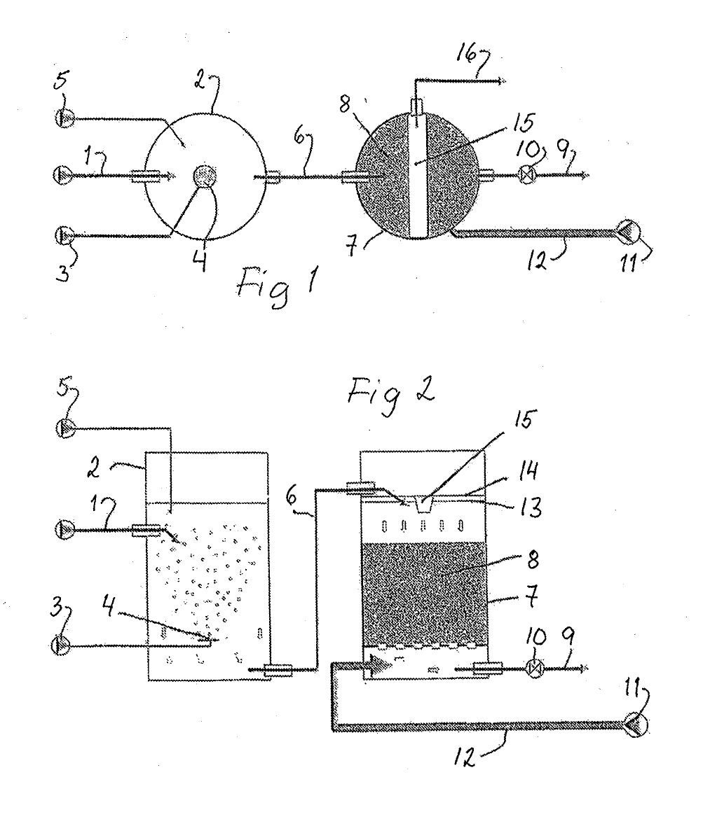

FIGS. 1 and 2 show a conventional water purification plant, mainly for purification of raw water with too high contents of iron, manganese and hydrogen sulphide.

Raw water 1 is pumped into an oxidation tank 2. An air compressor 3 supplies air to a nozzle device 4. The oxidation process may be enhanced by addition of a strong oxidation agent, such as potassium permanganate, from a dosing pump 5. Depending on the contents of iron, manganese and hydrogen sulphide in the raw water, the staying time for the raw water in the oxidation tank may normally be in the order of 20-30 minutes.

Due to the forceful agitation in the tank 2 by the air supplied through the nozzle device 4, particulate oxidation products of for example iron and manganese are prevented from sedimenting in the tank. These oxidation products will instead follow the water through a line 6 to the upper part of a filtration tank 7 containing a filter bed 8, through which the water passes by gravity, leaving the particulate matter in the filter bed 8, especially its upper part. Purified water leaves the lower part of the filtration tank 7 through a line 9 to a reservoir therefore.

After a certain time the upper part of the filter bed 8 will be clogged by the particulate matter. Such matter is removed by reverse flushing. Relatively large amounts of flush water under pressure are needed for accomplishing the desired cleaning of the filter bed 8. An outlet valve 10 in the line 9 is closed, and a reverse flush pump 11 is started supplying flush water to the lower part of the filtration tank 7 through a flush water line 12.

The water level in the filtration tank 7 rises from the normal level 13 to a higher level 14 from which the flush water with the flushed away particulate matter can enter an outlet trench 15 for further transport through an outlet line 16 to discharge.

The frequency of the reverse flushing is determined by the amount of particulate matter and the fineness of the filter material in the filter bed 8.

A further filter stage is often needed.

This purification plant is not suited for water containing organic material to be removed, such as sea or stream water.

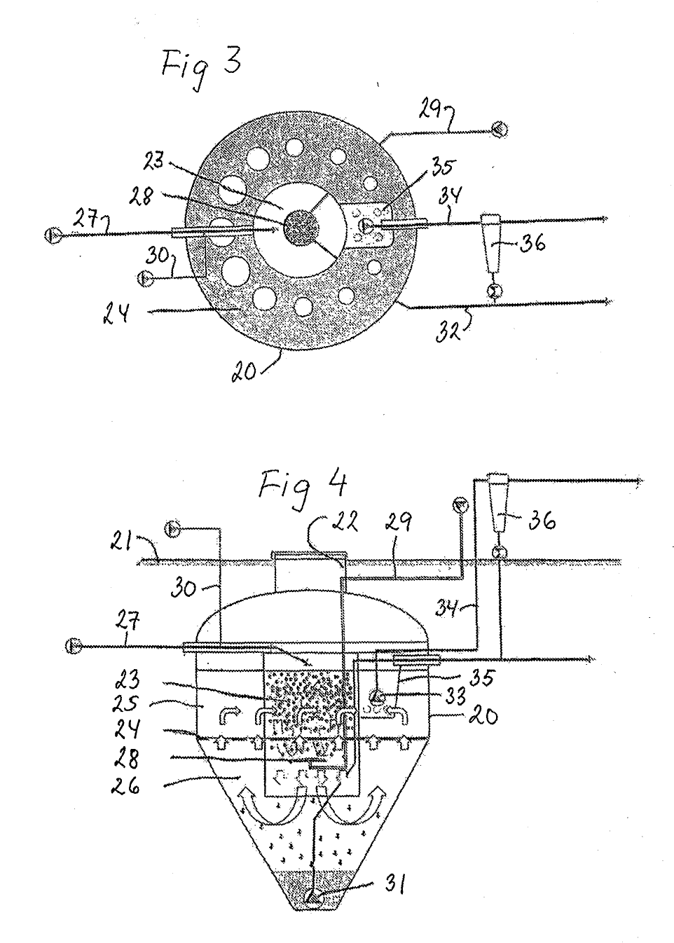

A water purification plant according to the invention is shown as two embodiments in FIGS. 3 and 4 and FIGS. 5 and 6, respectively. The two embodiments have much in common, and like numerals are used for like parts. The first embodiment is fully described, whereas the second one is only described to the extent necessary for a full understanding of the differences. As will be understood, the two embodiments may be combined.

Reference is first made to FIGS. 3 and 4. The water purification plant shown therein has a reservoir 20. As indicated by a ground level line 21, this reservoir may—if desired—be placed underground. The reservoir 20 may be manufactured of a suitable plastic material, but also the use of concrete for the reservoir is possible. The reservoir may preferably have a generally cylindrical cross-sectional shape. In the shown case it is inwardly tapering towards its lower end and has a cupola-shaped cover or upper end. It is provided with a neck 22, preferably opening above the ground level.

The reservoir 20 is internally provided, preferably centrally, with an inlet cylinder 23 with open ends both upwardly and downwardly. The upper end of the inlet cylinder 23 is above the water level in the reservoir 20 at all times.

A generally horizontal distribution disc 24 provided with openings divides the space inside the reservoir 20 and outside the inlet cylinder 23 into an upper and a lower compartment 25 and 26, respectively.

Unpurified raw water can be supplied to the inlet cylinder 23, for example through an inlet line 27, for example at a level above the distribution disc 24.

One or more nozzle devices 28 can be arranged in the inlet cylinder 23, for example at a level below the distribution disc 24. Air under certain pressure can be supplied to the nozzle device 28 through an air line 29. The purpose of the air supplied to the water through the nozzle device 28 is to agitate the water and/or to cause oxidation of such impurities in the raw water as iron, manganese and hydrogen sulphide.

If desired, the process may be enhanced by the addition of for example potassium permanganate as an oxidation agent through a line 30.

By the supply of new raw water, treated and aerated water will flow downwards through and out of the inlet cylinder 23. The precipitated materials, such as metallic iron or manganese, and other possible particles in the water will fall to the bottom of the reservoir 20, if the flow rate does not exceed 1 m³h per m² hydraulic load area of the distribution disc 24.

The precipitated materials can be removed from time to time from the bottom of the reservoir 20 as sludge by a sludge pump 31 through a sludge line 32.

The purified water will after leaving the inlet cylinder 23 downwards raise through and above the distribution disc 24, wherefrom it may be pumped away by a pure water pump 33 through a pure water line 34. The pure water pump 33 may be housed in a pump well 35 integrally mounted on the outside of the inlet cylinder 23. Alternatively, the water may be removed from the well 35 by gravity.

A further filtering means 36 may optionally be provided for the pure water supplied from the plant. This filtering means may be arranged to deliver its residue products to the sludge line 32. The flow rate may hereby be increased to some 1.5 m³h per m² hydraulic load of the distribution disc 24.

The size, number and distribution of the openings in the distribution disc 24 are determined such that a desired and evenly distributed flow through the plant over its entire cross-sectional area outside the inlet cylinder 23 is obtained and that oxidized matter is allowed to sink to the bottom of the reservoir 20 and is not carried along with the purified water.

It may be determined that with a diameter of 3 m for the reservoir 20 and a diameter of 1.5 m for the inlet cylinder 23, a capacity for the plant may be some 3 m³/h of purified raw water.

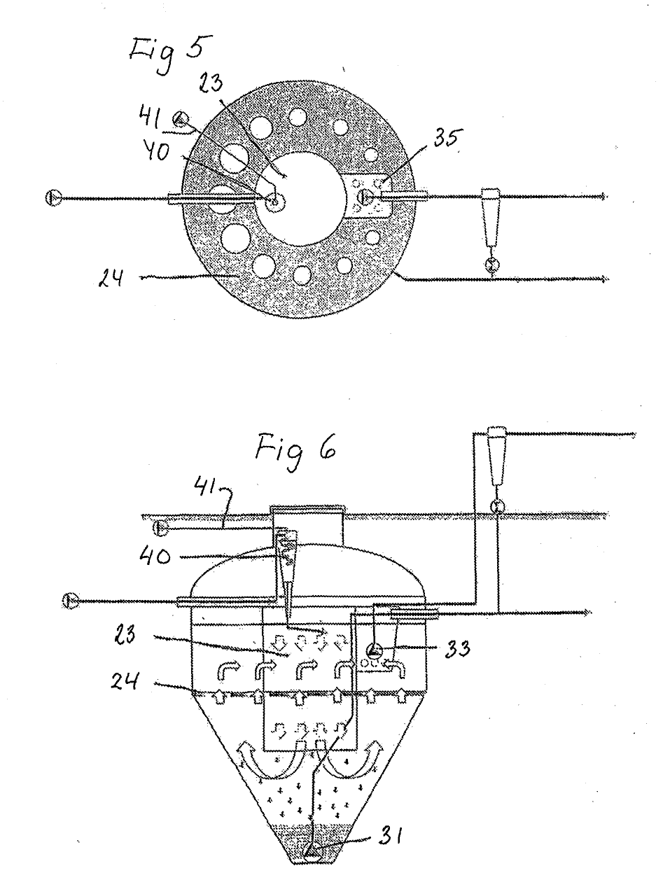

A second embodiment of a water purification plant is shown in FIGS. 5 and 6. This plant is mainly designed for purifying water containing organic material, such as humus in sea water or stream water. FIGS. 5 and 6 are only provided with numerals to the extent necessary for understanding the differences in relation to the first embodiment shown in FIGS. 3 and 4.

For removing the organic material from the supplied raw water, a suitable flocculating agent is added to the water in the inlet cylinder 23. This addition may preferably be arranged in a mixing cyclone 40, through which the raw water flows and to which the agent is supplied though a flocculating agent line 41. The raw water and the flocculating agent is effectively mixed and supplied to the inlet cylinder 23.

The treated water flows out of the inlet cylinder 23 and further though the distribution disc 24 as in the first embodiment. The formed flocks sink to the bottom, if the flow rate does not exceed 1 m³h per m² hydraulic load area of the distribution disc 24.

The second embodiment of the water purification plant shown in FIGS. 5 and 6 may be provided with an aeration system in the inlet cylinder 23 in accordance with the first embodiment. For the flocculating process to be optimally effective, it may be necessary not to supply too much air or to supply air only intermittently.

Modifications are possible within the scope of the appended claims.

1. A method of purifying raw water, comprising the steps of
supplying raw water to a generally vertical, open-ended inlet cylinder in a reservoir,
exposing the water in the inlet cylinder to air for accomplishing oxidizing of matter, such as iron, manganese, and hydrogen sulphide, in the water and/or agitation of the water,
allowing the oxidized matter to fall down by gravity to bottom of the reservoir,
allowing purified water to flow upwards past the inlet cylinder and through a distribution disc in the reservoir, and
removing the purified water from an upper part of the reservoir.

2. A method according to claim 1, wherein the water in the inlet cylinder is exposed to a flocculating agent for accomplishing flocculation of organic matter in the water, wherein flocculated organic matter being allowed to fall down by gravity to the bottom of the reservoir.

3. A water purification plant comprising:
a reservoir,
a generally vertical, open-ended inlet cylinder mounted in the reservoir and configured to receive raw water,
a device configured and arranged to separate matter heavier than water from the water in the inlet cylinder,
a generally horizontal distribution disc, provided with openings and dividing space inside the reservoir and outside the inlet cylinder into an upper and a lower compartment, wherein the lower compartment is configured to receive the matter heavier than water, and
means for removing purified water from the upper compartment.

4. A plant according to claim 3, wherein a sludge pump is arranged in the lower compartment at the bottom of the reservoir and configured to remove the matter heavier than water from the reservoir.

5. (canceled)

6. A plant according to claim 3, wherein the means for removing purified water comprises a pure water pump connected to a pure water line.

7. A plant according to claim 6, wherein the plant further comprises a filtering means arranged in the pure water line.

8. A plant according to claim 3, wherein the device is a mixing cyclone positioned before the inlet cylinder, wherein a flocculating agent line opens into the mixing cyclone, and wherein the raw water flows through mixing cyclone prior to entering the inlet cylinder.

9. A plant according to claim 3, wherein the openings are sized and distributed sufficient to achieve an even water flow over area of the distribution disc.

10. A plant according to claim 3, wherein a top edge of the inlet cylinder is positioned above water level in the reservoir.

11. A plant according to claim 3, wherein the device is a nozzle device positioned below bottom surface of the distribution disc.

12. A plant of claim 11, further comprising an air compressor and wherein the nozzle device is connected to the air compressor through an airline.

13. A plant of claim 12, further comprising an oxidation agent delivered to air pressure in the airline prior to entering the inlet cylinder.

14. A plant according to claim 3, wherein the bottom portion includes a tapered peripheral surface.

15. A plant according to 4, wherein the sludge pump is positioned in a narrow portion of the lower compartment.

16. A plant according to claim 6, wherein the plant includes a pump well positioned on the outside of the inlet cylinder, wherein top edge of the pump well is disposed in general alignment with a top edge of the inlet cylinder and a bottom edge of the pump well is disposed above the level of the distribution disk, wherein apertures are formed through a wall of the pump well in close proximity to the bottom edge thereof, and wherein the pure water pump is positioned inside the pump well.

17. A plant according to claim 7, wherein the filter is configured to deliver residue products to a sludge removing line.

18. A plant of claim 8, further comprising a nozzle device positioned inside the inlet cylinder and connected to an air compressor through an airline.

19. A plant of claim 1, further comprising a cupola-shaped cover.

20. A water purification plant comprising:
a reservoir having a generally open top end, a closed bottom end and downwardly tapered wall, wherein the bottom end is sized smaller than the top end,
an open-ended inlet cylinder mounted in the reservoir along the vertical axis thereof, wherein a top edge of the inlet cylinder is generally aligned with a top edge of the reservoir, wherein the top edge of the inlet cylinder is positioned above water level in the reservoir, and wherein the inlet cylinder is configured to receive raw water therein,
a distribution disc positioned generally horizontally inside the reservoir and dividing space inside the reservoir and outside the inlet cylinder into an upper and a lower compartment, wherein the lower compartment is configured to receive matter heavier than water,
a device configured and arranged to separate matter heavier than water from the raw water in the inlet cylinder,
openings formed through a thickness of the distribution disc, the openings sized and distributed sufficient to achieve an even water flow over area of the distribution disc and cause the matter heavier than water to fall by gravity toward the bottom end of the reservoir,
a sludge pump positioned inside the reservoir in close proximity to the bottom end thereof and configured to remove the matter heavier than water though a line connected to the sludge pump,
a pump well mounted integrally on the outside of the inlet cylinder, wherein a top edge of the pump well is disposed in general alignment with the top edge of the inlet cylinder and a bottom edge of the pump well is disposed above the level of the distribution disk and wherein apertures are formed through a wall of the pump well in close proximity to the bottom edge thereof, and
a pure water pump mounted positioned inside the pump well and connected to a pure water line existing the reservoir.

21. A plant according to 20, wherein the device includes at least one of a nozzle device positioned inside the inlet cylinder below the level of the distribution disc and a mixing cyclone positioned before the inlet cylinder, wherein the nozzle device is connected to an air compressor through an airline, wherein a flocculating agent line opens into the mixing cyclone, and wherein the raw water flows through mixing cyclone prior to entering the inlet cylinder.
